(19) United States
(12) Patent Application Publication
(10) Pub. No.: US 2006/0187901 A1
(43) Pub. Date: Aug. 24, 2006

(54) Concurrent dual-state proxy server, method of providing a proxy and SIP network employing the same

(75) Inventors: Mauricio Cortes, Scotch Plains, NJ (US); Jairo O. Esteban, Freehold, NJ (US)

Correspondence Address: HITT GAINES, PC;LUCENT TECHNOLOGIES INC., PO BOX 832570, RICHARDSON, TX, 75083, US

(73) Assignee: Lucent Technologies Inc., Murray Hill, NJ (US)

(21) Appl. No.: 11/064,167

(22) Filed: Feb. 23, 2005

(51) Int. Cl. H04L 12/66

(52) U.S. Cl. 370/352; 370/401

(57) ABSTRACT

The present invention provides a concurrent dual-state proxy server for use with a session initiation protocol (SIP) network. In one embodiment, the concurrent dual-state proxy server includes a request receiver configured to receive a SIP request. Additionally, the concurrent dual-state proxy server also includes a state-determination controller coupled to the request receiver and configured to process the SIP request employing a transaction mode that corresponds to a condition of the SIP network.

### TECHNICAL FIELD OF THE INVENTION

The present invention is directed, in general, to communication systems and, more specifically, to a concurrent dual-state proxy server, a method of providing a concurrent dual state proxy and a session initiation protocol (SIP) network employing the server or the method.

### BACKGROUND OF THE INVENTION

Session initiation protocol (SIP) is a signaling protocol used for creating, modifying and terminating sessions, such as IP voice calls or multimedia conferences, that have one or more participants in an IP network. SIP is a request-response protocol used in Voice over IP that closely resembles HTTP and SMTP, which are the two Internet protocols that power the World Wide Web and e-mail, respectively. The SIP user agent and the SIP proxy server are basic components that support the use of SIP. The SIP user agent is effectively the end system component for the call, and the SIP proxy server handles the signaling associated with multiple calls or requests. This architecture allows peer-to-peer calls to be accomplished using client-server protocol.

Accordingly, SIP proxy servers are employed as routing elements that read SIP messages, decide the next hop for the SIP message, and forward them to one or more SIP elements. SIP proxy servers make these decisions based on a number of factors. For example, some SIP proxy servers determine the next hop by examining the original message and retrieving information from a location server (e.g., dipping into a database). Other SIP proxy servers will calculate the next hop using a Domain Name Service. Yet other SIP proxy servers can determine the next hop based on the network traffic. As all of these examples suggest, the nature of SIP proxy servers is to route SIP messages towards the terminating user agent, possibly adding value in the message path. Initially, SIP message paths were small, including one or two proxies. The latest SIP networks have longer paths of about ten proxies.

SIP proxy servers are able to store information including messages, transactions, requests, dialogs, or sessions. These data help SIP proxy servers to add network-centric services in the message path. For example, SIP proxy servers can offload retransmission responsibilities from the previous hop using transaction information or support other services aimed at Quality of Service using dialog information. SIP proxy servers can process requests in a transaction stateful or a transaction stateless mode. The former maintains information to support a reliable exchange of messages thereby keeping track of SIP requests with adjacent SIP elements. In contrast, a stateless SIP proxy server does not store information about requests received or forwarded to its neighbors.

A SIP transaction contains information about the message exchange between two adjacent SIP elements, such as incoming or ongoing requests and their corresponding responses. The SIP transaction stores information to allow the absorption of incoming retransmissions and the generation of new retransmissions associated with these adjacent SIP elements. In particular, transaction stateful SIP proxy servers create two types of transactions, which are called server and client transactions. The former supports the message exchange between the previous hop element and the SIP proxy server, while the latter supports the message exchange between the SIP proxy server and the next hop element. Conversely, a SIP dialog represents the entire communication from end point to end point for the user agents involved. Dialog stateful SIP proxy servers keep track of SIP dialogs to support a number of services. For example, they can allocate or de-allocate network resources when dialogs are established and terminated, respectively.

Currently, SIP proxy servers process all SIP requests either as transaction stateful or as transaction stateless. Additionally, each transaction typically programs a number of timers to indicate when to retransmit a message or give up on a request, for example. Therefore, SIP transactions consume a significant amount of CPU cycles thereby making current SIP proxy servers CPU-intensive applications. In particular, current SIP proxy servers employing transaction stateful applications use a large amount of CPU cycles doing transaction-related work even when the SIP request or SIP network conditions do not merit a transaction stateful mode. Conversely, when these SIP proxy servers employ current transaction stateless applications, they do not store any state information associated with request, dialog or call properties even if would be beneficial to do so.

Accordingly, what is needed in the art is an enhanced way to accommodate SIP transactions based on the requirements of each SIP request and its associated network environment.

### SUMMARY OF THE INVENTION

To address the above-discussed deficiencies of the prior art, the present invention provides a concurrent dual-state proxy server for use with a session initiation protocol (SIP) network. In one embodiment, the concurrent dual-state proxy server includes a request receiver configured to receive a SIP request. Additionally, the concurrent dual-state proxy server also includes a state-determination controller coupled to the request receiver and configured to process the SIP request employing a transaction mode that corresponds to a condition of the SIP network.

In another aspect, the present invention provides a method of providing a concurrent dual-state proxy for use with a session initiation protocol (SIP) network. The method includes receiving a SIP request and processing the SIP request employing a transaction mode that corresponds to a condition of the SIP network.

The present invention also provides, in yet another aspect, a session initiation protocol (SIP) network. The SIP network includes an Internet protocol (IP) domain employing multiple user agents and a concurrent dual-state proxy server coupled to the multiple user agents. The concurrent dual-state proxy server has a request receiver that receives a SIP request from the multiple user agents and a state-determination controller, coupled to the request receiver, that processes the SIP request employing a transaction mode that corresponds to a condition within the SIP network.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a network diagram of a SIP network employing a concurrent dual-state proxy server constructed in accordance with the principles of the present invention;

FIG. 2 illustrates a block diagram of a concurrent dual-state proxy server constructed in accordance with the principles of the present invention;

FIG. 3 illustrates a diagram of an embodiment of a portion of a server stack employable with a CDS proxy server and constructed in accordance with the principles of the present invention; and

FIG. 4 illustrates a flow diagram of an embodiment of a method of providing a concurrent dual-state proxy carried out in accordance with the principles of the present invention.

### DETAILED DESCRIPTION

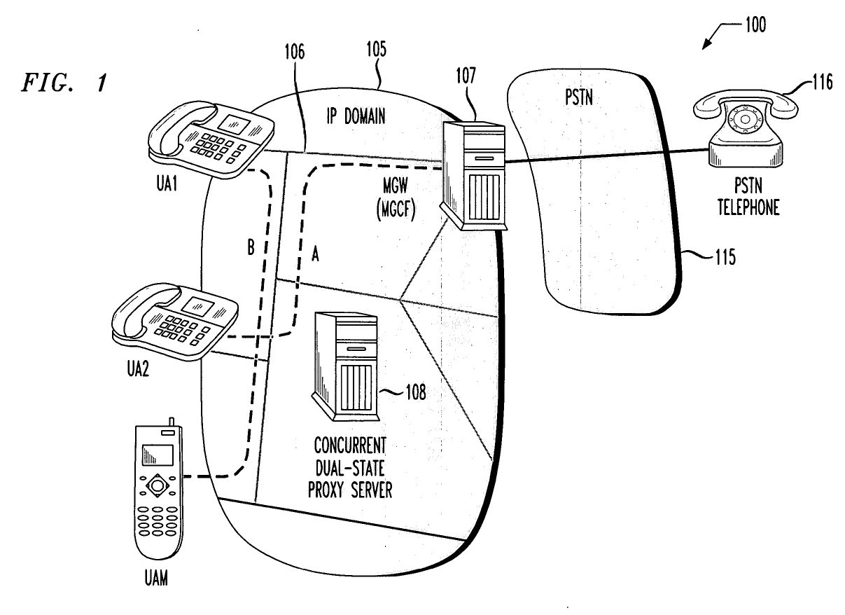

Referring initially to FIG. 1, illustrated is a network diagram of a SIP network, generally designated 100, employing a concurrent dual-state proxy server that is constructed in accordance with the principles of the present invention. The SIP network 100 includes an Internet protocol (IP) domain 105 employing a topology of routing options 106 and a public switched telephone network (PSTN) domain 115. The SIP network 100 employs an IP multimedia subsystem (IMS) service architecture that supports the deployment of Voice over IP. Additionally, the SIP network 100 is a hybrid network that employs both wireless and wireline network portions, and the routing options 106 include SIP user agent cable company technology and routings. In alternate embodiments of the present invention, the SIP network 100 may be solely wireless or solely wireline as a particular embodiment may dictate.

The IP domain 105 includes a media gateway 107, a concurrent dual-state (CDS) proxy server 108, first and second stationary user agents UA1, UA2 and a mobile user agent UAM. The PSTN domain 115 includes a PSTN telephone 116. Any of the user agents UA1, UA2, UAM may employ a portion of the topology of routing options 106 to support a call with the PSTN telephone 116 using the media gateway 107 and the CDS proxy server 108, as exemplified by path A of FIG. 1. Additionally, the user agents UA1, UA2, UAM may also be employed to support a call employing the CDS proxy server 108, as exemplified by path B of FIG. 1. The media gateway 107 performs a bridging function between the IP domain 105 and the PSTN domain 115 thereby enabling calls between the PSTN telephone 116 and the user agents UA1, UA2, UAM within the IP domain 105.

The CDS proxy server 108 includes a request receiver that receives a SIP request and a state-determination controller, coupled to the request receiver, which processes the SIP request employing a transaction mode that corresponds to a condition of the SIP network. The condition of the SIP network 100 is selected from the group consisting of an application load, a network characteristic such as bandwidth or error rate, a SIP message type and a computational resource such as CPU usage or memory availability of the CDS proxy server 108, for example. Additionally, the condition may include a next hop handling of the SIP request or static information about neighboring SIP elements as may advantageously be employed in a particular embodiment of the present invention.

The CDS proxy server 108 supports both transaction stateful and transaction stateless modes concurrently and provides dynamic switching from transaction stateless to transaction stateful modes, if needed. Additionally, the CDS proxy server 108 stores information about a request state, a dialog state or a call state independently from being transaction stateless or transaction stateful. The CDS proxy server 108 provides an initial bias towards being transaction stateless when processing the SIP request, thereby providing a conservative bias toward network resources and accommodating both normal and overload conditions of the SIP network 100.

The CDS proxy server 108 is a multi-state (call, dialog, request, transaction) SIP proxy server that stores information depending on a number of factors including network conditions and the availability of local computational resources. This approach provides an enhanced usage of network and computational resources allowing accommodation at runtime to changes associated with resource usage. If the CDS proxy server 108 is exchanging messages with another SIP element over a highly reliable network path, then no transaction information is needed since retransmissions are unlikely. On the other hand, if the CDS proxy server 108 exchanges SIP messages over a lossy network, it stores transaction state and retransmits messages as often as needed. This characteristic allows the CDS proxy server 108 to achieve a better throughput by using stateless and stateful functionality depending on the request, the network, and computer resources available. Therefore, the CDS proxy server 108 can decide which functionality to use depending on the runtime conditions.

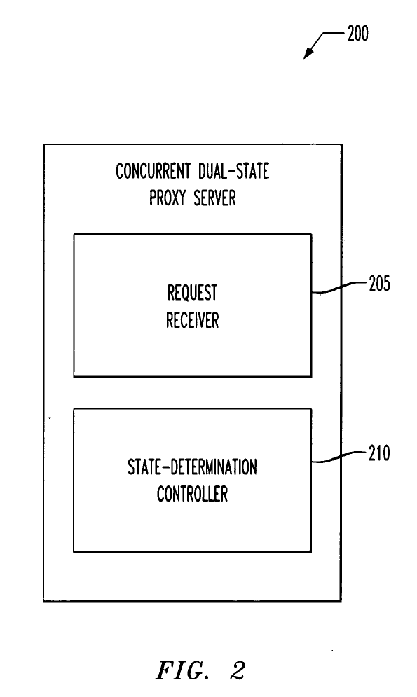

Turning now to FIG. 2, illustrated is a block diagram of a concurrent dual-state proxy server, generally designated 200, constructed in accordance with the principles of the present invention. The concurrent dual-state (CDS) proxy server 200 may be employed with a SIP network and includes a request receiver 205 and a state-determination controller 210. As discussed with respect to FIG. 1, the request receiver 205 is configured to receive a SIP request. Additionally, the state-determination controller 210 is coupled to the request receiver 205 and is configured to process the SIP request employing a transaction mode that corresponds to a condition of the SIP network. In general, the CDS proxy server 200 provides for the co-location of transaction stateless and transaction stateful functionality, dynamic switching from stateless to stateful mode and independence of request, dialog and transaction states.

The co-location of transaction stateless and stateful functionality provides the ability to operate as either a transaction stateless or stateful application for new requests and responses. This ability employs a decision capability that is applied to any new request. Initially, the CDS proxy server 200 may determine that a server transaction is to be created for a request message. In this case, client transactions are also created and the CDS proxy server 200 behaves as a transaction stateful application for that particular request. Alternately, the CDS proxy server 200 may determine that no server or client transactions are to be created, thus behaving as a transaction stateless application. Also, the CDS proxy server 200 may determine that only client transactions are created (i.e., no server transaction), thus behaving as a transaction stateless application from the originating standpoint, and a transaction stateful application from the terminating standpoint.

In an alternative embodiment, a fourth combination employing a server transaction only may be allowed. However, this is not compliant with the existing SIP standard since the creation of a server transaction requires the creation of client transactions. Therefore, the stack associated with the CDS proxy server 200 may be simultaneously behaving as transaction stateless for some requests and transaction stateful for others. Moreover, it could be behaving as transaction stateless to one side and transaction stateful to the other side on the same request.

In the illustrated embodiment, the CDS proxy server 200 may make the decision about transaction creation based on several factors, which may include a request type, a current load condition, a link quality and a previous or subsequent hop. For the request type, the CDS proxy server 200 may be provisioned such that some requests are always treated statefully or statelessly (e.g., an application may decide to always process INVITE messages statefully). For the current load condition, the CDS proxy server 200 may employ a protective measure against CPU, memory and network overload that initially processes any new request statelessly as a precursor to a more severe protection measure, such as rejecting messages.

For link quality, the stack associated with the CDS proxy server 200 may have some level of knowledge about the quality of all associated links by provisioning or monitoring the SIP network. High bandwidth, low-packet-loss links have a higher reliability and therefore may typically not require the use of transactions (e.g., a gigabit TCP connection between an I-CSCF and a S-CSCF in the same LAN). On the other hand, low bandwidth, high-packet-loss connections (like mobile radio), may require the use of transactions to deal with retransmissions.

For the case of previous or subsequent hops, the CDS proxy server 200 may employ provisioning or analysis of information contained in each message to determine if the previous or subsequent hop is a stateful application and may rely on a neighboring element to deal with retransmissions (e.g., the arrival of a “100-trying” message indicates that the subsequent hop is treating the request statefully). From the point of view of the stack associated with the CDS proxy server 200, the implementation of this feature requires that the decision be made at the transport layer. For new requests, this layer delivers the message to the next layer in the stack, along with an indicator that indicates that the state is to be stored.

In the illustrated embodiment, the CDS proxy server 200 may switch to a stateful mode for an existing request being treated statelessly, in at most 200 milliseconds. This may happen in response to changing conditions in processing the particular request. The CDS proxy server 200 may also employ switching to a stateless mode, although it is not always possible. For example, if the stack has disclosed that the request is going to be treated statefully (e.g., by sending a “100 Trying” message), the CDS proxy server 200 is required to remain transaction stateful for the request.

Furthermore, the CDS proxy server 200 can switch modes between two requests dealing with the same session or call. For example, it can process the initial INVITE request in stateful mode, but process the BYE request in stateless mode, or vice-versa. The decision to process a dialog-initiating request does not force the CDS proxy server 200 application to process the dialog-terminating request similarly. This flexibility provides the CDS proxy server 200 stack with the ability to react to sudden changes in its environment, not only by making decisions on incoming requests, but also by changing its behavior with active requests.

The CDS proxy server 200 stack is able to store request, dialog, and call state independently of being transaction stateless or stateful. This makes it possible to process a particular request as transaction stateless and dialog stateful. A transaction state is often required to accommodate retransmissions and forking. If the CDS proxy server 200 application determines that no transactions are required for a particular request, it can still decide to store dialog and call state (e.g., for billing purposes). Therefore, the CDS proxy server 200 allows the decision to store dialog state to be independent of the decision to store transaction state.

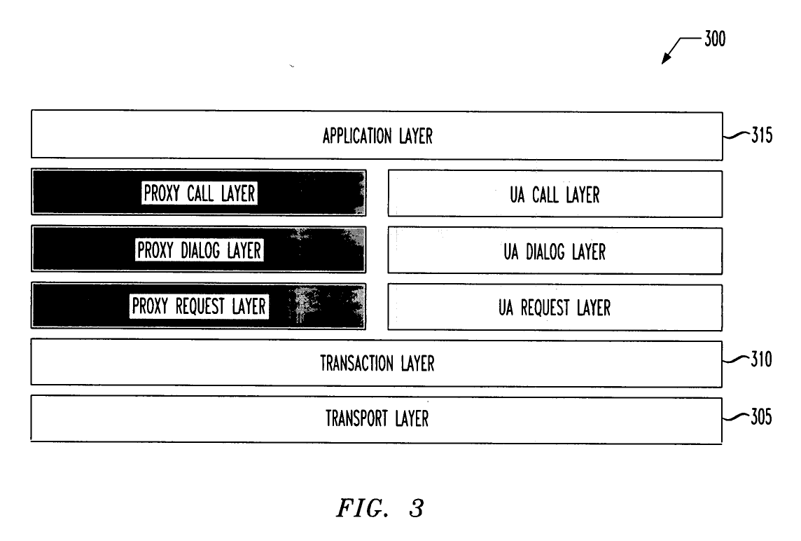

Turning now to FIG. 3, illustrated is a diagram of an embodiment of a portion of a server stack, generally designated 300, employable with a CDS proxy server and constructed in accordance with the principles of the present invention. The server stack 300 is a layered architecture that incorporates a guiding principle of the independence of each level. Each of the layers of the architecture is optional, with the exception of a transport layer 305, regardless of the presence or absence of other tiers below and above it. Another important feature of this architecture is that every layer can be active or passive. Active layers define their own execution threads and interact with other layers by message queues, while passive layers provide an interface consisting of function calls. In this way, applications can use the server stack 300 in uniprocessor and multiprocessor machines, in single-threaded and multi-threaded environments.

Additionally, each layer can be provisioned with a set of callbacks to be invoked when important events occur (e.g., a transaction layer 310 can be provisioned with a callback function to report that a transaction was terminated). These callback functions are routines that can be installed for every layer in the server stack 300. Therefore, these callback functions provide a flexible mechanism for developing how messages will be routed through the different stack layers.

From the point of view of the server stack 300, the implementation of co-location of transaction stateless and stateful functionality requires that a decision be made at the transport layer 305, which is applied to new incoming messages retrieved by the layer. The transport layer 305 delivers the message to the next level, along with the output of the decision, which is an indicator recommending either statefully or statelessly processing. The message is not necessarily delivered to the transaction layer 310, although this may be the common case. The actual layer that receives the message depends upon the configuration of the callback functions. On receiving the message from the transport layer 310, the next layer can follow the recommendation of processing it either statefully or statelessly. Alternatively, it can also ignore the recommendation and provide its own decision. This may occur as a consequence of changes in the environment, or information retrieved by the corresponding layer that is not accessible to the decision of the transport layer. Therefore, the decision of operating statelessly or statefully is distributed across different layers. As a result of this feature, each message can be processed in a different mode (e.g., statefully or statelessly) in each of the layers in the server stack 300, depending on the message itself, and current processing conditions.

Two hundred milliseconds after receiving a request, the server stack 300 is able to switch to a stateful mode for an existing request being treated statelessly. This may happen in response to changing conditions in the particular request processing. Switching to the stateless mode from the stateful mode may also be accommodated for some cases as was discussed earlier. This flexibility provides the server stack 300 with the ability to react to sudden changes in its environment, not only by making decisions on incoming requests, but also by changing its behavior with regard to active requests.

Any layer, especially the transaction layer 310, can decide to store state for a particular message in the middle of the processing, even though it initially decided not to do so. Similarly, it can decide to discard the current state and not to store it. Switching from the stateless to stateful mode may not necessarily be disclosed to the next or previous hops in the path. The application program interface associated with the server stack 300 provides the function calls to switch to either mode and to validate if such switching is possible at that time. Typically, the decision about switching to a different mode is made at an application level (in an application layer 315), and is triggered by emerging situations, like a sudden increase of traffic causing an overload condition or the quality indicators of a particular link beginning to deteriorate.

The server stack 300 is able to store request, dialog, and call state, independently of being transaction stateless or stateful thereby allowing a particular request to be transaction stateless and dialog stateful, for example. Recall that the transaction state is mostly required to accommodate request retransmissions and forking. If the server stack 300 determines that no transactions are required for a particular request, it can still store dialog and call state independently of the decision to store transaction state. Therefore, the server stack 300 tolerates the existence of calls, dialogs, and requests with no subrogate objects.

Providing this kind of flexibility requires that the server stack 300 is not strictly hierarchical. As mentioned before, each layer can exist regardless of the existence of layers below and above it. However, some constraints exist for the layers that are present in a particular stack configuration (e.g., a request layer is never below the transaction layer 310 or the transport layer 305).

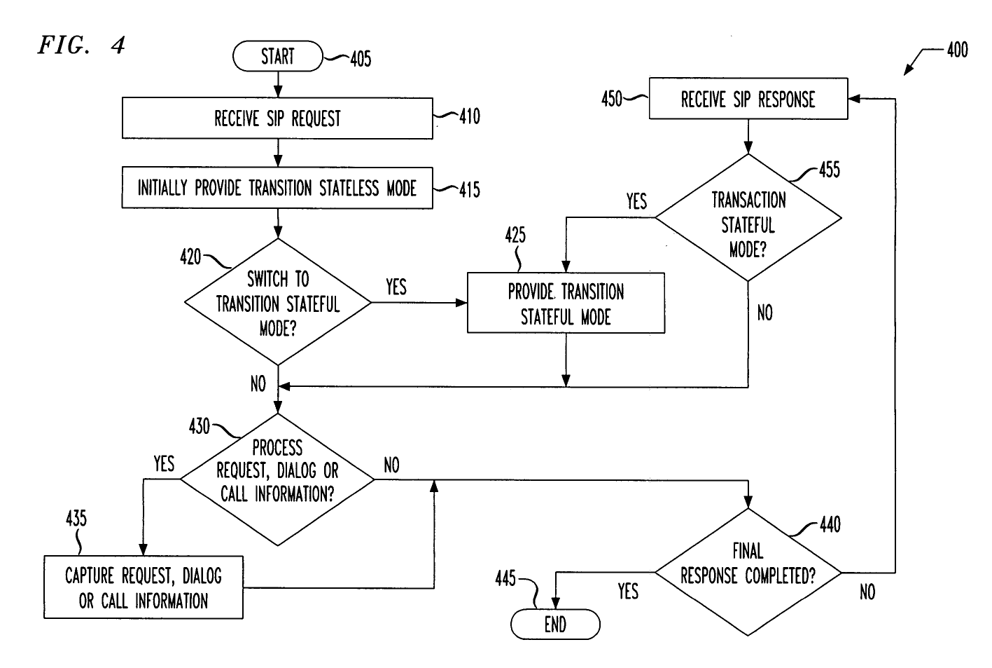

Turning now to FIG. 4, illustrated is a flow diagram of an embodiment of a method of providing a concurrent, dual-state proxy, generally designated 400, carried out in accordance with the principles of the present invention. The method 400 is for use with a SIP network and starts in a step 405. Then in a step 410, a SIP request is received and a transition stateless mode is initially provided as a means of conserving resources in a step 415. In a first decisional step 420, it is determined if the SIP request is to remain transition stateless or if it is to be switched to a transition stateful mode. If a transition stateful mode is to be employed, it is provided in a step 425.

At the conclusion of the step 425 or if it is determined that a transmission stateless mode is maintained in the first decisional step 420, a second decisional step 430 determines if request, dialog or call information is to be stored. If it is determined that any of this information is to be stored, it is captured in a step 435. At the conclusion of the step 435, or if it is determined that request, dialog or call information is not to be stored for this request, a third decisional step 440 determines if a request has been completed. If the request is complete, the method 400 ends in a step 445.

If the transaction is not complete as determined in the third decisional step 440, the method 400 is forwarded to a step 450 wherein a SIP response is received. A fourth decisional step 455 determines if the response in the step 450 corresponds to a transaction. If a transaction is associated with this response, it is processed in the context of the corresponding transaction in the step 425. At the conclusion of the step 425 or if the outcome of the fourth decisional step 455 is negative, the method 400 again proceeds to the second decisional step 430 and progresses to the third decisional step 440 until the request is complete. Then, the method 400 again ends in the step 445.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a concurrent dual-state proxy server, a method of providing a concurrent dual-state proxy and a SIP network employing the server or the method have been presented. Advantages include the ability to provide a SIP proxy server that co-locates both transaction stateless and transaction stateful functionalities concurrently. By providing both, the performance advantage associated with stateless functionality and the reliability provided by stateful functionality allow enhanced adaptation to network and computational conditions. It may be shown that for a typical SIP request, the ability to process the SIP request reliability employing a transaction stateless mode provides a reduction of approximately 45 percent in the number of abstractions required when compared to employing corresponding transaction stateful applications. This provides a substantial reduction in needed network and computational resources.

Although the present invention has been described in detail, those skilled in the art should understand that they can make various changes, substitutions and alterations herein without departing from the spirit and scope of the invention in its broadest form.

What is claimed is:

1. A concurrent dual-state proxy server for use with a session initiation protocol (SIP) network, comprising:
a request receiver configured to receive a SIP request; and
a state-determination controller coupled to said request receiver and configured to process said SIP request employing a transaction mode that corresponds to a condition of said SIP network.

2. The proxy server as recited in claim 1 wherein transaction stateful and transaction stateless modes are supported concurrently.

3. The proxy server as recited in claim 1 wherein dynamic switching from a transaction stateless to a transaction stateful mode is provided.

4. The proxy server as recited in claim 1 wherein information is stored about at least one of a request state, a dialog state and a call state independently of said SIP request being transaction stateless and transaction stateful.

5. The proxy server as recited in claim 1 wherein processing said SIP request is provided with an initial bias towards being transaction stateless.

6. The proxy server as recited in claim 1 wherein said condition of said SIP network is selected from the group consisting of:
an application load;
a network characteristic;
a SIP message type;
a CPU usage;

7. The proxy server as recited in claim 1 wherein said SIP request is associated with an agent selected from the group consisting of:
a stationary user agent; and
a mobile user agent.

8. A method of providing a concurrent dual-state proxy for use with a session initiation protocol (SIP) network, comprising:
receiving a SIP request; and
processing said SIP request employing a transaction mode that corresponds to a condition of said SIP network.

9. The method as recited in claim 8 wherein transaction stateful and transaction stateless modes are supported concurrently.

10. The method as recited in claim 8 wherein dynamic switching from a transaction stateless to a transaction stateful mode is provided.

11. The method as recited in claim 8 wherein information is stored about at least one of a request state, a dialog state and a call state independently of said SIP request being transaction stateless and transaction stateful.

12. The method as recited in claim 8 wherein said processing said SIP request is provided with an initial bias towards being transaction stateless.

13. The method as recited in claim 8 wherein said condition of said SIP network is selected from the group consisting of:
an application load;
a network characteristic;
a SIP message type;
a CPU usage;

14. The proxy server as recited in claim 8 wherein said SIP request is associated with an agent selected from the group consisting of:
a stationary user agent; and
a mobile user agent.

15. A session initiation protocol (SIP) network, comprising:
an Internet protocol (IP) domain employing multiple user agents; and
a concurrent dual-state proxy server coupled to said multiple user agents, including:
a request receiver that receives a SIP request from said multiple user agents, and
a state-determination controller, coupled to said request receiver, that processes said SIP request employing a transaction mode that corresponds to a condition within said SIP network.

16. The network as recited in claim 15 wherein transaction stateful and transaction stateless modes are supported concurrently.

17. The network as recited in claim 15 wherein dynamic switching from a transaction stateless to a transaction stateful mode is provided.

18. The network as recited in claim 15 wherein information is stored about at least one of a request state, a dialog state and a call state independently of said SIP request being transaction stateless and transaction stateful.

19. The network as recited in claim 15 wherein processing said SIP request provides an initial bias towards being transaction stateless.

20. The network as recited in claim 15 wherein said condition of said SIP network is selected from the group consisting of:
an application load;
a network characteristic;
a SIP message type;
a CPU usage;

21. The network as recited in claim 15 wherein said SIP request is associated with an agent selected from the group consisting of:
a stationary user agent; and
a mobile user agent.
